(19) United States
(12) Patent Application Publication
(10) Pub. No.: US 2009/0176144 A1
(43) Pub. Date: Jul. 9, 2009

(54) FUEL CELL MODULE

(75) Inventors: Fang Bor WENG, Jhongli City (TW); Su Ay, Jhongli City (TW); Chun-Ying Hsu, Jhongli City (TW); Chih-Hung Lee, Jhongli City (TW)

Correspondence Address: EGBERT LAW OFFICES, 412 MAIN STREET, 7TH FLOOR, HOUSTON, TX, 77002, US

(73) Assignee: YUAN ZE UNIVERSITY, Jhongli City (TW)

(21) Appl. No.: 11/971,359

(22) Filed: Jan. 9, 2008

(51) Int. Cl. H01M 2/08

(52) U.S. Cl. 429/35

(57) ABSTRACT

The present invention provides a fuel cell, including a composite bipolar plate and gasket connecting bipolar plate. A sub-channel is assembled at a concave side of the gasket corresponding with bipolar plate. Main channels of gas running through both sides of the bipolar plate are arranged at separation positions between the bipolar plate and gas sub-channel. The main channels of gas and the gas sub-channel are connected through the channel. The airtight layer is assembled between the bipolar plate and gasket. With the airtight layer, the bipolar plate and gasket can be locked and fixed together steadily and tightly, so that the spaces of flow channels for different fuels can be definitely separated, without any leakage and mistaken mixture.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a fuel cell, and more particularly to an innovative fuel cell having a bipolar plate with a phase surface of a tight structure type.

2. Description of Related Art Including Information Disclosed Under 37 CFR 1.97 and 37 CFR 1.98

In the structure of a common fuel cell, the bipolar plate is set at both sides of the membrane electrolyte assembly. The bipolar plate must employ highly conductive and easily processed materials. At present, common materials for a bipolar plate comprise graphite, aluminum, stainless steel, and so on. The phase surface of the bipolar plate is provided with a flow channel as the channel conducting fuel, so that the expected reaction gas (such as hydrogen and oxygen) can reach gas diffusion layer set between the bipolar plates via the channel and can get to a catalyst layer, where the electrochemical transformation reaction is aroused to generate current. With the function of current conductivity provided by the bipolar plates, the current can be conducted to a preset external loop.

It should be well understood that the phase surface between the bipolar plate and gas diffusion layer is stiff and closely attached, thus the phase surface must be processed to a extremely high degree of plainness. The required degree of airtightness of contact degree in this way, greatly increases processing costs and rates of defects, which does not conform to economic interests of the industry. Moreover, although the phase surface between the bipolar plate and gas diffusion layer reaches a required degree of plainness, when the bipolar plate of the composite set and gas diffusion layer are pressed, the fixed phase surface between the bipolar plate and gas diffusion layer may be deformed because of partial stress caused by a press point of fasteners, such as a bolt or rivet. Though the deformation degree is a very small, the gap in the phase surface between the bipolar plate and gas diffusion layer may be generated because it is a stiff surface.

Therefore, because of the different properties of conducted fuel, such as hydrogen and oxygen, the flow channels set between bipolar plates should be separated, so that the different fuels can be conducted in comparatively different directions from gas diffusion layer, following preset routes, to generate expected medical reactions. In other words, the airtight state of the phase surface between the bipolar plate and gas diffusion layer is a significant factor to determine whether nor not the channel spaces for different fuels can be assuredly separated. From this, the gaps, which are produced easily in the phase surface between bipolar plate and gas diffusion layer, will cause fuels of different properties to be mixed before they come to the gas diffusion layer. Such early mixture may result in different problems and potential risks because of a different mixture state of different fuels. To a slight extent, these problems and risks may exert negative influences on generation efficiency of fuel cells. To a serious extent, they may bring about risky explosions because of the reaction caused by direct contact of extremely plentiful fuels, such as hydrogen and oxygen, of different properties. Obviously, the matter, at present, is a crucial one which should be resolved as soon as possible in the structure of composite fuel cells of bipolar plates.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

With innovative and unique structures, a soft airtight layer is arranged between the bipolar plate and the gasket. When compared with known structures in the prior art, it is impossible to make the combination of the bipolar plate and gasket to easily reach a steady and close state and to reduce the requirement of processing precision for the surface of the bipolar plate and gasket and decreasing the rate of defects and manufacturing costs. With the arranging of the soft airtight layer, flow channel spaces of different fuels can be definitely separated, and any leakage and mistaken mixture can be avoided, which further improves the quality of fuel cells to a great extent and practical benefits for safety.

With the structures of a hard support gasket added between the bipolar plate and soft airtight layer, a hard face shaped support can be provided for the side of the soft airtight layer facing the bipolar plate. With the capacity of preventing protrusion at the opening side in the channel of the soft airtight layer corresponding with bipolar plate, assembly quality of the fuel cell module can be further improved.

With the channel being made into a concave shape, the processing tool of the same axis can be applied to mill and shape the channel for one time in manufacturing and shaping of the channel and in processing of gas sub-channels in the bipolar plates. Manufacturing efficiency of the bipolar plate, reducing manufacturing costs, and providing more industrial use benefits are improved.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled cross-sectional view of the preferred embodiment of the present invention.

FIG. 2 shows an exploded perspective view of partial components of the present invention.

FIG. 3 shows another cross-sectional view of the assembled present invention, showing the gas flow state.

FIG. 4 shows a top plan view of the bipolar plate of the present invention.

FIG. 5 shows an isolated exploded partial perspective view of the bipolar plate, soft airtight layer, and parts of hard support gasket of the present invention.

FIG. 6 shows another partial perspective view of a combination state, as shown in FIG. 5.

FIG. 7 shows a perspective view of the structure with a shaped soft airtight layer of the present invention.

FIG. 8 shows another perspective view of the structure with a shaped soft airtight layer of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

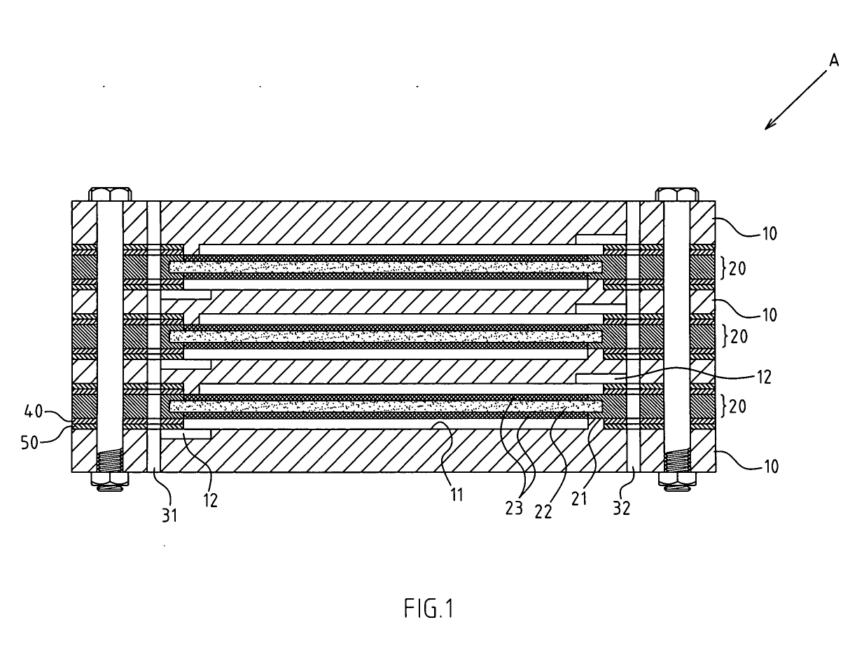

FIGS. 1-3 depict preferred embodiments of the structure of a fuel cell module of the present invention. The embodiments are only provided for explanatory purposes with respect to the patent claims.

The fuel cell module A comprises a composite bipolar plate 10, having a gasket 20 connected thereto and a sub-channel 11 set in a side concave of the bipolar plate 10 corresponding with gasket 20. The sub-channel 11 can be snake-shaped. Moreover, main channel 31 of the first gas and main channel 32 of the second gas which run through side faces of the bipolar plate 10 are set in the separation position of the bipolar plate 10 and gas sub-channel 11. With main channel 31 and 32, different fuel reaction gases can be conducted, such as hydrogen and oxygen. The main channel 31 and 32 are connected to gas sub-channel 11 with the channel 12.

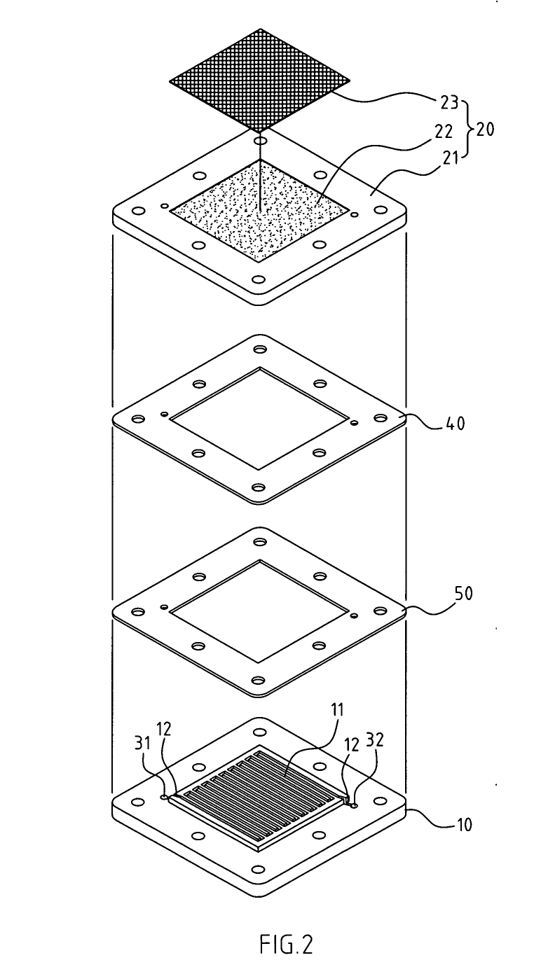

A soft airtight layer 40 is set between the bipolar plate 10 and gasket 20. The soft airtight layer 40, shown in the FIG. 2, can be gasket-shaped and made of rubber or silica gel. With elastic airtightness, when bipolar plate 10 and gasket 20 are mutually connected and fixed, the soft airtight layer 40 can be applied to achieve a preferred airtight state.

Structure of the gasket 20 is shown in FIGS. 1 and 2, comprising base plate 21, membrane electrolyte assembly 22 set in the middle preset position of base plate 21, and gas diffusion layer 23 set in the membrane electrolyte assembly 22.

The channel 12 can be concave, whose opening side is covered by soft airtight layer 40. A section of the concave channel 12 can be rectangular.

Hard support gasket 50 can be set between the bipolar plate 10 and soft airtight layer 40, being made of a thin metal sheet or thin plastic sheet. The purpose of hard support gasket 50 is to provide hard support for the side of bipolar plate 10 facing soft airtight layer 40. When the opening side of channel 12 in the side of bipolar plate 10 and a relative position of soft airtight layer 40 are mutually pressed, the opening side of channel 12 may protrude because of uneven stress on soft airtight layer 40. With the strong support of hard support gasket 50, the matter can be solved.

The composite bipolar 10 and gasket 20 can be locked and fixed through bolt 60 and nut 61, when they are connected.

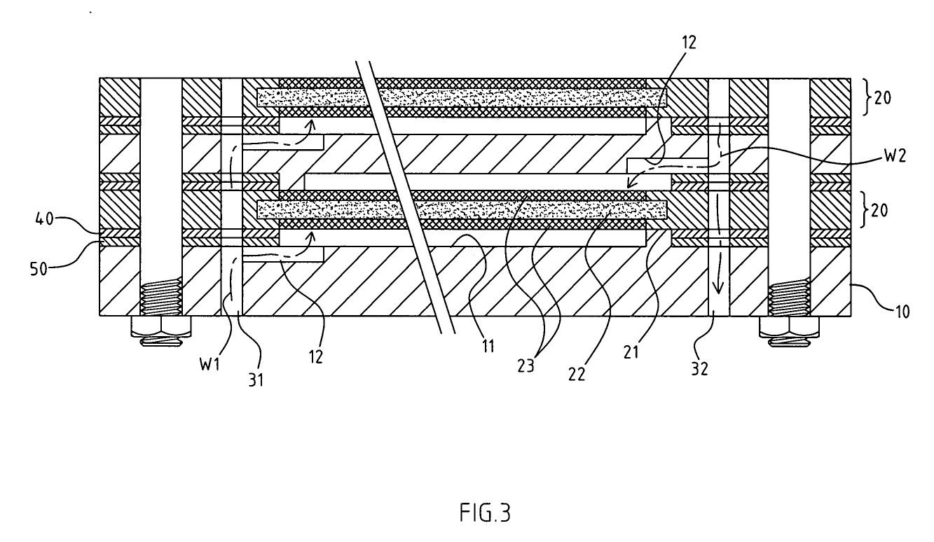

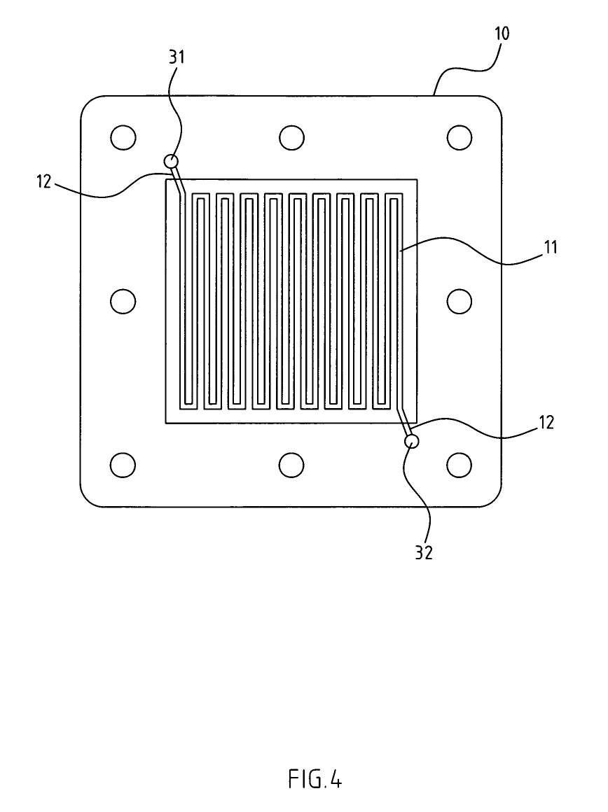

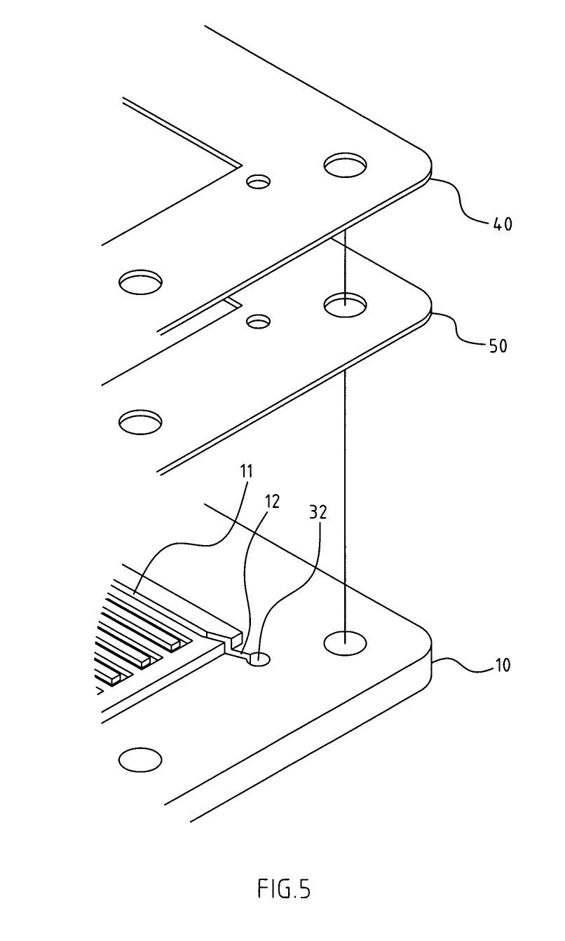

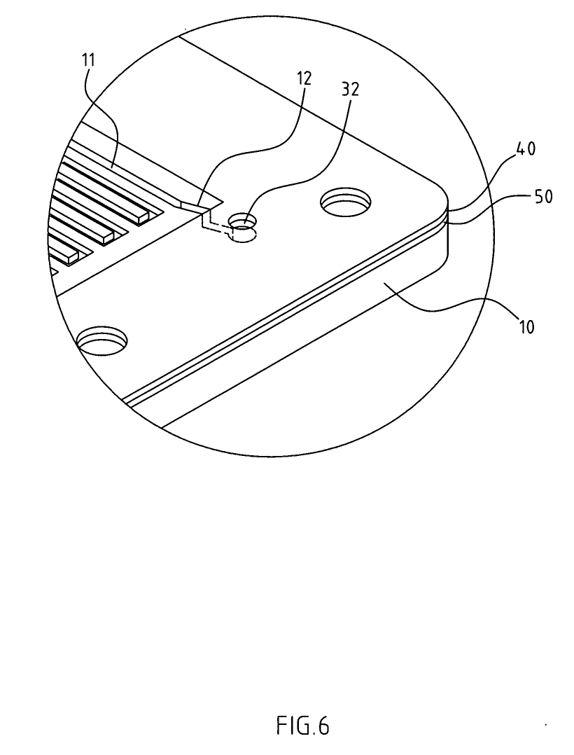

With the structure of the present invention, FIG. 1 depicts the connection state of overall bipolar plate 10 of fuel cell module A and gasket 20. FIG. 3 depicts their operation. Different gases W1 and W2 (such hydrogen and oxygen) are conducted in through main gas channel 31 and 32. The different gases, W1 and W2, permeate channel 12 set in bipolar plate 10 at different sides of gasket 20 and gas sub-channel 11. The gases W1 and W2 get to gas diffusion layer 21 of gasket 20 and membrane electrolyte assembly 22, to arouse reaction. Chemical energy is transformed into electric energy. In the course of operation, with the setting of the soft airtight layer 40, the connection state of each group of bipolar plate 10 and gasket 20 can achieve an optimal airtight state, so that different gases, W1 and W2, can flow along the preset channel, without any leakage and mistaken mixture.

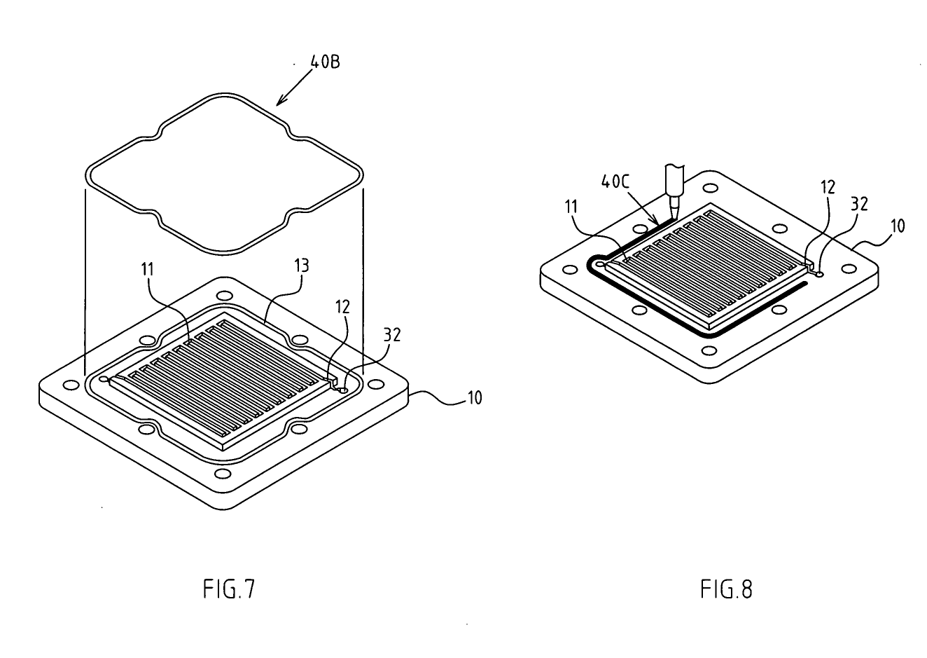

FIG. 7 depicts another embodiment of the soft airtight layer of the structure. The soft airtight layer 40B in the embodiment is a loop strip type (similar to an 0 loop type), made of rubber, silica gel or other flexible materials. Such soft airtight layer 40B of loop strip type can be flexibly shaped to coordinate the position of bolt 60 and the distribution position of gas sub-channel 11. Moreover, the surface of the bipolar plate 10 can form concave 13 to insert soft airtight layer 40B of loop strip type for stabilizing locator.

FIG. 8 depicts another preferred embodiment of the soft airtight layer of a structural type. Soft airtight layer 40C in the embodiment is a layer structure shaped by a cloth-coated method.

We claim:

1. A fuel cell module, comprising:
a composite bipolar plate, having at least one concave side and a gas sub-channel on said concave side, said composite bipolar plate having sides separated according to a first main channel of a first gas and a second main channel of a second gas running through both sides of the bipolar plate, the main channels of said first gas and said second gas being connected to said gas sub-channel by a channel;
gasket, connected to said concave side of said gas sub-channel; and
an airtight layer, arranged between the bipolar plate and said gasket.

2. The fuel cell defined in claim 1, wherein said airtight layer is gasket shaped.

3. The fuel cell defined in claim 1, wherein said airtight layer is loop strip shaped.

4. The fuel cell defined in claim 1, wherein said airtight layer is cloth-coated shaped.

5. The fuel cell defined in claim 1, further comprising:
a support gasket arranged between said composite bipolar plate and said airtight layer.

6. The fuel cell defined in claim 1, wherein said gasket is comprised of a base plate, a membrane electrolyte assembly and gas diffusion layer set at both sides of said membrane electrolyte assembly.

7. The fuel cell defined in claim 1, wherein said channel is concave, said channel having an opening side covered by said airtight layer.

8. The fuel batter defined in claim 7, wherein said channel has a rectangular section.
